(19) United States
(12) Patent Application Publication
(10) Pub. No.: US 2023/0182293 A1
(43) Pub. Date: Jun. 15, 2023

(54) SYSTEMS AND METHODS FOR GRASP PLANNING FOR A ROBOTIC MANIPULATOR

(71) Applicant: Boston Dynamics, Inc., Waltham, MA (US)

(72) Inventors: Samuel Shaw, Somerville, MA (US); Logan W. Tutt, Boston, MA (US); Shervin Talebi, Wayland, MA (US); C. Dario Bellicoso, Boston, MA (US); Jennifer Barry, Arlington, MA (US); Neil M. Neville, Waltham, MA (US)

(73) Assignee: Boston Dynamics, Inc., Waltham, MA (US)

(21) Appl. No.: 17/988,982

(22) Filed: Nov. 17, 2022

Related U.S. Application Data
(60) Provisional application No. 63/288,308, filed on Dec. 10, 2021.

(51) Int. Cl. B25J 9/16

(52) U.S. Cl. CPC B25J 9/1661; B25J 9/1664

(57) ABSTRACT

Methods and apparatus for determining a grasp strategy to grasp an object with a gripper of a robotic device are described. The method comprises generating a set of grasp candidates to grasp a target object, wherein each of the grasp candidates includes information about a gripper placement relative to the target object, determining, for each of the grasp candidates in the set, a grasp quality, wherein the grasp quality is determined using a physical-interaction model including one or more forces between the target object and the gripper located at the gripper placement for the respective grasp candidate, selecting, based at least in part on the determined grasp qualities, one of the grasp candidates, and controlling the robotic device to attempt to grasp the target object using the selected grasp candidate.

### CROSS REFERENCE TO RELATED APPLICATIONS

This application claims the benefit under 35 U.S.C. § 119(e) of U.S. Provisional application Ser. No. 63/288,308, filed Dec. 10, 2021, and entitled, “SYSTEMS AND METHODS FOR GRASP PLANNING FOR A ROBOTIC MANIPULATOR,” the disclosure of which is incorporated by reference in its entirety.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

Robotic devices may be configured to grasp objects (e.g., boxes) and move them from one location to another using, for example, a robotic arm with a vacuum-based gripper attached thereto. For instance, the robotic arm may be positioned such that one or more suction cups of the gripper are in contact with (or are near) a face of an object to be grasped. An on-board vacuum system may then be activated to use suction to adhere the object to the gripper. The placement of the gripper on the object presents several challenges. In some scenarios, the object face to be grasped may be smaller than the gripper, such that at least a portion of the gripper will hang off of the face of the object being grasped. In other scenarios, obstacles within the environment where the object is located (e.g., a wall or ceiling of an enclosure such as a truck) may prevent access to one or more of the object faces. Additionally, even when there are multiple feasible grasps, some grasps may be more secure than others. Ensuring a secure grasp on an object is important for moving the object efficiently and without damage (e.g., from dropping the object due to loss of grasp).

Some embodiments are directed to quickly determining a high-quality, feasible grasp to extract an object from a stack of objects without damage. A physics-based model of gripper-object interactions can be used to evaluate the quality of grasps before they are attempted by the robotic device. Multiple candidate grasps can be considered, such that if one grasp fails a collision check or is enacted on a part of the object with poor integrity, other (lower ranking) grasping options are available to try. Such fallback grasp options help to limit the need for grasping-related interventions (e.g., by humans), increasing the throughput of the robotic device. Additionally, by selecting higher quality grasps, the number of objects dropped can be reduced, leading to fewer damaged products and overall faster object movement by the robotic device.

One aspect of the disclosure provides a method of determining a grasp strategy to grasp an object with a gripper of a robotic device. The method comprises generating, by at least one computing device, a set of grasp candidates to grasp a target object, wherein each of the grasp candidates includes information about a gripper placement relative to the target object, determining, by the at least one computing device, for each of the grasp candidates in the set, a grasp quality, wherein the grasp quality is determined using a physical-interaction model including one or more forces between the target object and the gripper located at the gripper placement for the respective grasp candidate, selecting, by the at least one computing device based at least in part on the determined grasp qualities, one of the grasp candidates, and controlling, by the at least one computing device, the robotic device to attempt to grasp the target object using the selected grasp candidate.

In another aspect, generating a grasp candidate in the set of grasp candidates comprises selecting a gripper placement relative to the target object, determining whether the selected gripper placement is possible without colliding with one or more other objects in an environment of the robotic device, and generating the grasp candidate in the set of grasp candidates when it is determined that the selected gripper placement is possible without colliding with one or more other objects in the environment of the robotic device.

In another aspect, the method further comprises rejecting the grasp candidate for inclusion in the set of grasp candidates when it is determined that the selected gripper placement is not possible without colliding with one or more other objects in the environment of the robotic device.

In another aspect, the method further comprises determining that at least one object other than the target object is capable of being grasped at a same time as the target object, and determining the information about the gripper placement for the grasp candidate to grasp both the target object and the at least one object other than the target object at the same time.

In another aspect, generating a grasp candidate in the set of grasp candidates comprises determining, based on the information about the gripper placement, a set of suction cups of the gripper to activate, and associating with the grasp candidate, information about the set of suction cups of the gripper to activate.

In another aspect, determining the grasp quality for a respective grasp candidate using a physical-interaction model is further based, at least in part, on the information about the set of suction cups of the gripper to activate.

In another aspect, the method further comprises representing in the physical-interaction model, forces between the target object and each suction cup in the set of suction cups of the gripper to activate, and determining the grasp quality for the respective grasp candidate based on an aggregate of the physical-interaction model forces between the target object and each suction cup in the set of suction cups of the gripper to activate.

In another aspect, determining the set of suction cups of the gripper to activate comprises including, in the set of suction cups, all suction cups in the gripper completely overlapping a surface of the target object.

In another aspect, the set of grasp candidates includes a first grasp candidate having a first offset relative to the target object and a second grasp candidate having a second offset relative to the target object, the second offset being different than the first offset.

In another aspect, the first offset is relative to a center of mass of the target object and the second offset is relative to the center of mass of the target object.

In another aspect, the set of grasp candidates includes a first grasp candidate having a first orientation relative to the target object and a second grasp candidate having a second orientation relative to the target object, the second orientation being different than the first orientation.

In another aspect, selecting based, at least in part, on the determined grasp qualities, one of the grasp candidates comprises selecting the grasp candidate in the set of grasp candidates with the highest grasp quality.

In another aspect, the method further comprises assigning, by the at least one computing device, to each of the grasp candidates in the set of grasp candidates a score based, at least in part, on the grasp quality associated with the grasp candidate, and selecting, by the at least one computing device, the grasp candidate with the highest score.

In another aspect, the method further comprises determining, by the at least one computing device, whether the selected grasp candidate is feasible, and performing, by the at least one computing device, at least one action when it is determined that the selected grasp candidate is not feasible.

In another aspect, performing at least one action comprises selecting a different grasp candidate from the set of grasp candidates.

In another aspect, selecting a different grasp candidate from the set of grasp candidates is performed without modifying the set of grasp candidates.

In another aspect, selecting a different grasp candidate from the set of grasp candidates comprises selecting the grasp candidate with a next highest grasp quality.

In another aspect, performing at least one action comprises selecting a different target object to grasp.

In another aspect, performing at least one action comprises controlling, by the at least one computing device, the robotic device to drive to a new position closer to the target obj ect.

In another aspect, determining whether the selected grasp candidate is feasible is based, at least in part, on at least one obstacle located in an environment of the robotic device.

In another aspect, the at least one obstacle includes a wall or ceiling of an enclosure in the environment of the robotic device.

In another aspect, determining whether the selected grasp candidate is feasible is based, at least in part, on a movement constraint of an arm of the robotic device that includes the gripper.

In another aspect, the method further comprises measuring, a grasp quality between the gripper and the target object after controlling the robot to attempt to grasp the target obj ect.

In another aspect, the method further comprises selecting, by the at least one computing device, a different grasp candidate from the set of grasp candidates when the measured grasp quality is less than a threshold amount.

In another aspect, the method further comprises controlling the robotic device to lift the target object when the measured grasp quality is greater than a threshold amount.

In another aspect, the method further comprises receiving, by the at least one computing device, a selection of the target object to grasp by the gripper of the robotic device.

Another aspect of the disclosure provides a robotic device. The robotic device comprises a robotic arm having disposed thereon, a suction-based gripper configured to grasp a target object, and at least one computing device. The at least one computing device is configured to generate a set of grasp candidates to grasp the target object, wherein each of the grasp candidates includes information about a gripper placement relative to the target object, determine, for each of the grasp candidates in the set, a grasp quality, wherein the grasp quality is determined using a physical-interaction model including one or more forces between the target object and the gripper located at the gripper placement for the respective grasp candidate, select based, at least in part, on the determined grasp qualities, one of the grasp candidates, and control the arm of the robotic device to attempt to grasp the target object using the selected grasp candidate.

In another aspect, generating a grasp candidate in the set of grasp candidates comprises selecting a gripper placement of the suction-based gripper relative to the target object, determining whether the selected gripper placement is possible without colliding with one or more other objects in an environment of the robotic device, and generating the grasp candidate in the set of grasp candidates when it is determined that the selected gripper placement is possible without colliding with one or more other objects in the environment of the robotic device.

In another aspect, the suction-based gripper includes one or more suction cups, and the at least one computing device is further configured to determine, based on the information about the gripper placement, a set of suction cups of the one or more suction cups to activate, and associate with the grasp candidate, information about the set of suction cups of the one or more suction cups to activate.

In another aspect, the at least one computing device is further configured to measure a grasp quality between the gripper and the target object after controlling the robot to attempt to grasp the target object, select a different grasp candidate from the set of grasp candidates when the measured grasp quality is less than a threshold amount, and control the robotic arm to lift the target obj ect when the measured grasp quality is greater than the threshold amount.

Another aspect of the disclosure provides a non-transitory computer readable medium encoded with a plurality of instructions that, when executed by at least one computing device, perform a method. The method comprises generating a set of grasp candidates to grasp a target object, wherein each of the grasp candidates includes information about a gripper placement relative to the target object, determining for each of the grasp candidates in the set, a grasp quality, wherein the grasp quality is determined using a physical-interaction model including one or more forces between the target object and the gripper located at the gripper placement for the respective grasp candidate, selecting based at least in part on the determined grasp qualities, one of the grasp candidates, and controlling the robotic device to attempt to grasp the target object using the selected grasp candidate.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of one embodiment of a robot;

FIG. 1B is another perspective view of the robot of FIG. 1A;

FIG. 2A depicts robots performing tasks in a warehouse environment;

FIG. 2B depicts a robot unloading boxes from a truck;

FIG. 2C depicts a robot building a pallet in a warehouse aisle;

FIG. 3 is an illustrative computing architecture for a robotic device that may be used in accordance with some embodiments;

FIG. 4 is a flowchart of a process for detecting and grasping objects by a robotic device in accordance with some embodiments;

FIG. 5A is a flowchart of a process for determining a grasp strategy for grasping a target object in accordance with some embodiments;

FIG. 5B is a flowchart of a process for generating and evaluating a set of grasp candidates to determine a grasp strategy for grasping a target object in accordance with some embodiments;

FIG. 6A is a schematic representation of a top-pick grasp strategy of a target object in accordance with some embodiments;

FIGS. 6B and 6C are force diagrams of physical interaction forces between a gripper and a target object using two different top-pick grasp strategies in accordance with some embodiments;

FIG. 7A is a schematic representation of a face-pick grasp strategy of a target object in accordance with some embodiments;

FIG. 7B is a force diagram of physical interaction forces between a gripper and a target object using a face-pick grasp strategy in accordance with some embodiments;

FIG. 8A is a force diagram of calculating a net force associated with a face-pick grasp strategy in accordance with some embodiments;

FIG. 8B schematically illustrates activation of a subset of the suction cups in a gripper depending on a placement of the gripper relative to a target object in accordance with some embodiments;

FIG. 9 is a flowchart of a process for generating a grasp candidate in a set of grasp candidates in accordance with some embodiments;

FIG. 10A schematically illustrates three different gripper offset placements relative to a target object;

FIG. 10B schematically illustrates activation of a subset of the suction cups in a gripper depending on a placement of the gripper relative to a target object in accordance with some embodiments; and

FIG. 11 schematically illustrates a multi-pick assessment in which at least one object neighboring a target object are grouped into a new target object for grasping by the gripper of a robotic device in accordance with some embodiments.

### DETAILED DESCRIPTION

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor belt, and a second person at the opposite end of the conveyor belt might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions. Such robots may either be specialist robots (i.e., designed to perform a single task, or a small number of closely related tasks) or generalist robots (i.e., designed to perform a wide variety of tasks). To date, both specialist and generalist warehouse robots have been associated with significant limitations, as explained below.

A specialist robot may be designed to perform a single task, such as unloading boxes from a truck onto a conveyor belt. While such specialist robots may be efficient at performing their designated task, they may be unable to perform other, tangentially related tasks in any capacity. As such, either a person or a separate robot (e.g., another specialist robot designed for a different task) may be needed to perform the next task(s) in the sequence. As such, a warehouse may need to invest in multiple specialist robots to perform a sequence of tasks, or may need to rely on a hybrid operation in which there are frequent robot-to-human or human-to-robot handoffs of objects.

In contrast, a generalist robot may be designed to perform a wide variety of tasks, and may be able to take a box through a large portion of the box's life cycle from the truck to the shelf (e.g., unloading, palletizing, transporting, depalletizing, storing). While such generalist robots may perform a variety of tasks, they may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible. Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task. As should be appreciated from the foregoing, the mobile base and the manipulator in such systems are effectively two separate robots that have been joined together; accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while there are limitations that arise from a purely engineering perspective, there are additional limitations that must be imposed to comply with safety regulations. For instance, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not a pose a threat to the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, the inventors have recognized and appreciated that a highly integrated mobile manipulator robot with system-level mechanical design and holistic control strategies between the manipulator and the mobile base may be associated with certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

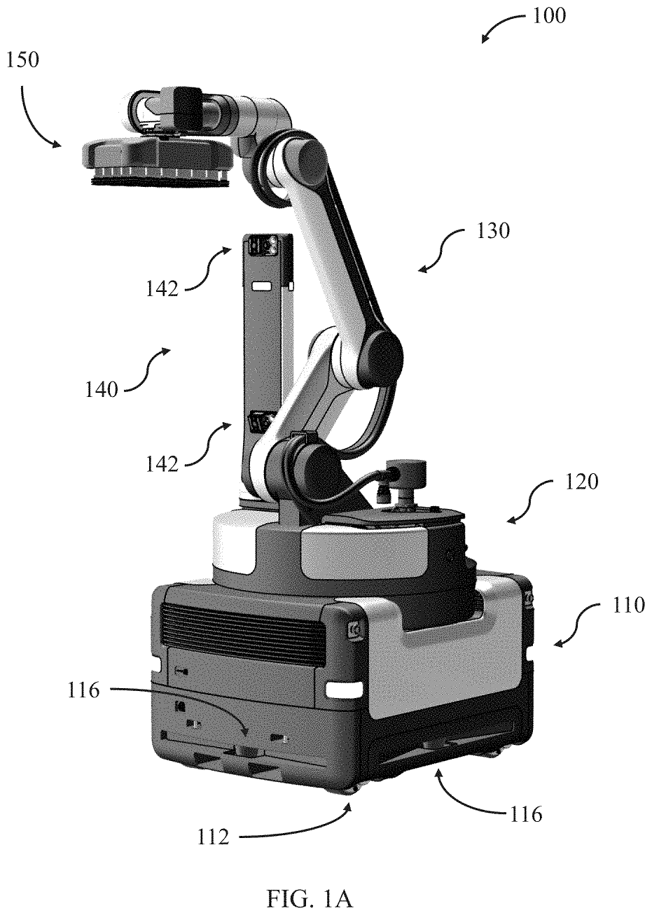

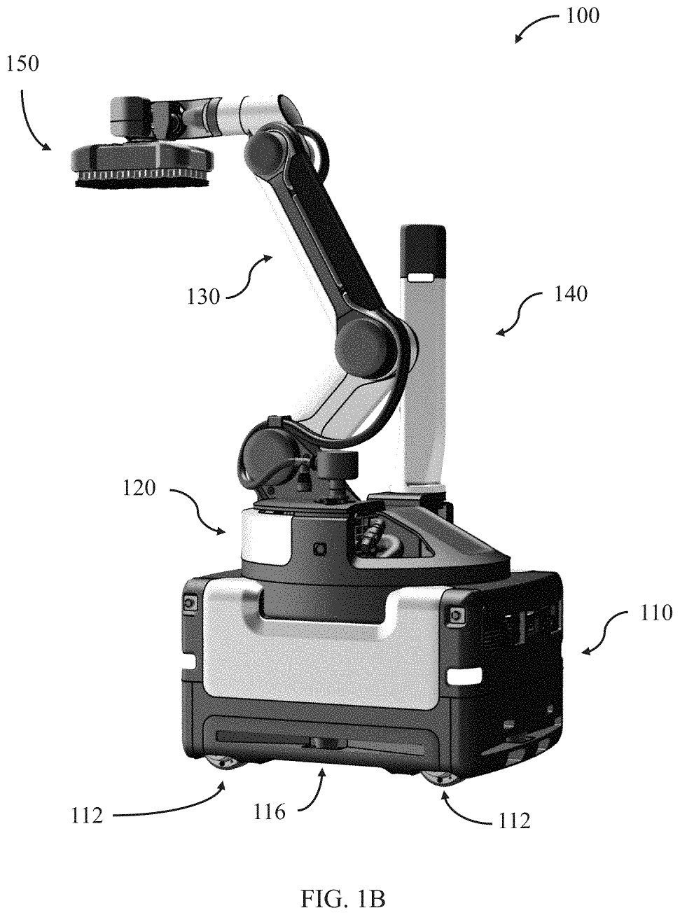

FIGS. 1A and 1B are perspective views of one embodiment of a robot 100. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

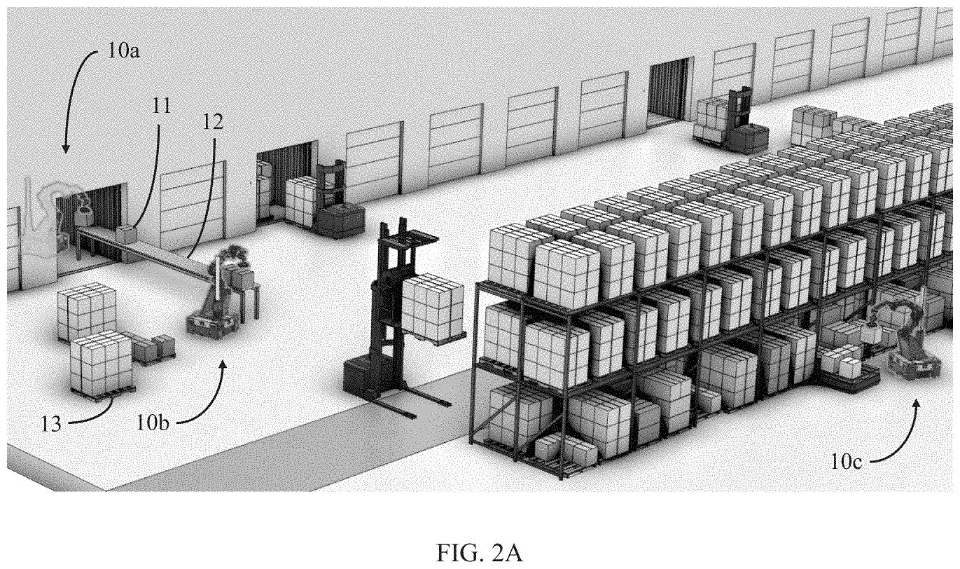

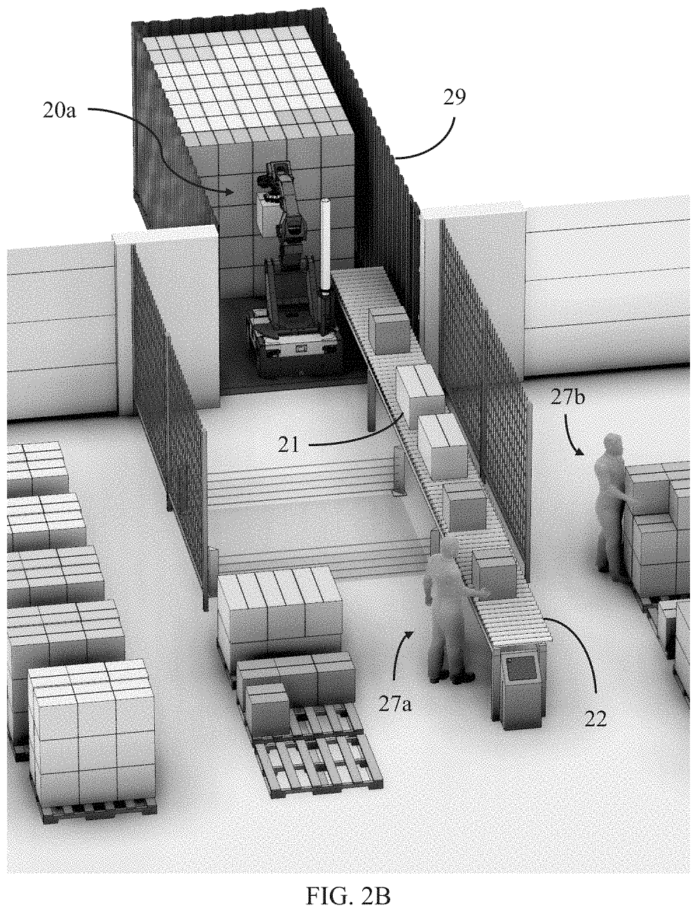

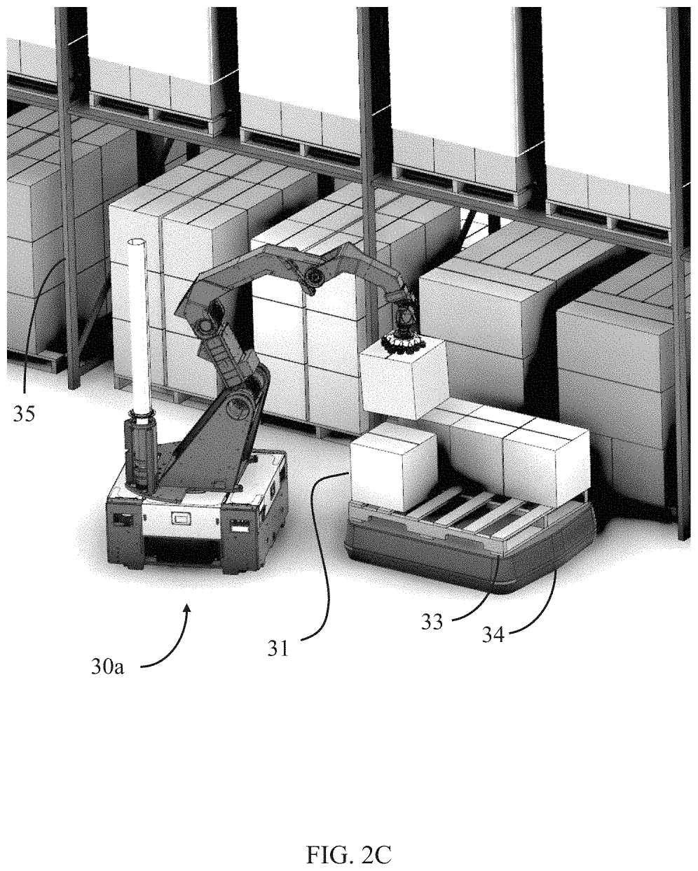

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). It should be appreciated that the robots 10a, 10b, and 10c are different instances of the same robot (or of highly similar robots). Accordingly, the robots described herein may be understood as specialized multi-purpose robots, in that they are designed to perform specific tasks accurately and efficiently, but are not limited to only one or a small number of specific tasks.

FIG. 2B depicts a robot 20a unloading boxes 21 from a truck 29 and placing them on a conveyor belt 22. In this box picking application (as well as in other box picking applications), the robot 20a will repetitiously pick a box, rotate, place the box, and rotate back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B. During operation, the perception mast of robot 20a (analogous to the perception mast 140 of robot 100 of FIGS. 1A and 1B) may be configured to rotate independent of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety zone around the robot into which humans are prevented from entering.

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

Of course, it should be appreciated that the tasks depicted in FIGS. 2A-2C are but a few examples of applications in which an integrated mobile manipulator robot may be used, and the present disclosure is not limited to robots configured to perform only these specific tasks. For example, the robots described herein may be suited to perform tasks including, but not limited to, removing objects from a truck or container, placing objects on a conveyor belt, removing objects from a conveyor belt, organizing objects into a stack, organizing objects on a pallet, placing objects on a shelf, organizing objects on a shelf, removing objects from a shelf, picking objects from the top (e.g., performing a “top pick”), picking objects from a side (e.g., performing a “face pick”), coordinating with other mobile manipulator robots, coordinating with other warehouse robots (e.g., coordinating with AMRs), coordinating with humans, and many other tasks.

### Example Computing Device

Control of one or more of the robotic arm, the mobile base, the turntable, and the perception mast may be accomplished using one or more computing devices located on-board the mobile manipulator robot. For instance, one or more computing devices may be located within a portion of the mobile base with connections extending between the one or more computing devices and components of the robot that provide sensing capabilities and components of the robot to be controlled. In some embodiments, the one or more computing devices may be coupled to dedicated hardware configured to send control signals to particular components of the robot to effectuate operation of the various robot systems. In some embodiments, the mobile manipulator robot may include a dedicated safety-rated computing device configured to integrate with safety systems that ensure safe operation of the robot.

The computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the terms “physical processor” or “computer processor” generally refer to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

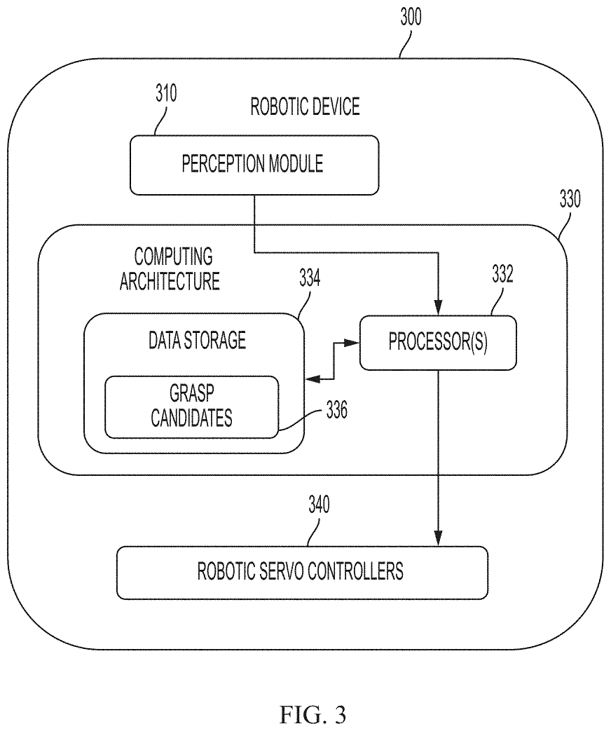

FIG. 3 illustrates an example computing architecture 330 for a robotic device 300, according to an illustrative embodiment of the invention. The computing architecture 330 includes one or more processors 332 and data storage 334 in communication with processor(s) 332. Robotic device 300 may also include a perception module 310 (which may include, e.g., the perception mast 140 shown and described above in FIGS. 1A-1B). The perception module 310 may be configured to provide input to processor(s) 332. For instance, perception module 310 may be configured to provide one or more images to processor(s) 332, which may be programmed to detect one or more objects in the provided one or more images for grasping by the robotic device. Data storage 334 may be configured to store a set of grasp candidates 336 used by processor(s) 332 to represent possible grasp strategies for grasping a target object. Robotic device 300 may also include robotic servo controllers 340, which may be in communication with processor(s) 332 and may receive control commands from processor(s) 332 to move a corresponding portion of the robotic device. For example, after selection of a grasp candidate from the set of grasp candidates 336, the processor(s) 332 may issue control instructions to robotic servo controllers 340 to control operation of an arm and/or gripper of the robotic device to attempt to grasp the object using the grasp strategy described in the selected grasp candidate.

During operation, perception module 310 can perceive one or more objects (e.g., boxes) for grasping (e.g., by an end-effector of the robotic device 300) and/or one or more aspects of the robotic device's environment. In some embodiments, perception module 310 includes one or more sensors configured to sense the environment. For example, the one or more sensors may include, but are not limited to, a color camera, a depth camera, a LIDAR or stereo vision device, or another device with suitable sensory capabilities. In some embodiments, image(s) captured by perception module 310 are processed by processor(s) 332 using trained box detection model(s) to extract surfaces (e.g., faces) of boxes or other objects in the image capable of being grasped by the robotic device 300.

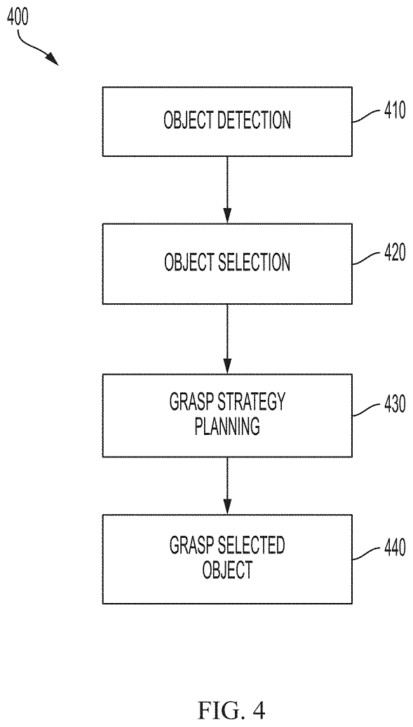

FIG. 4 illustrates a process 400 for grasping an object (e.g., a parcel such as a box) using an end-effector of a robotic device in accordance with some embodiments. In act 410, objects of interest to be grasped by the robotic device are detected in one or more images (e.g., RGBD images) captured by a perception module of the robotic device. For instance, the one or more images may be analyzed using one or more trained object detection models to detect one or more object faces in the image(s). Following object detection, process 400 proceeds to act 420, where a particular “target” object of the set of detected objects is selected (e.g., to be grasped next by the robotic device). In some embodiments, a set of objects capable of being grasped by the robotic device (which may include all or a subset of objects in the environment near the robot) may be determined as candidates for grasping. Then, one of the candidates may be selected as the target object for grasping, wherein the selection is based on various heuristics, rules, or other factors that may be dependent on the particular environment and/or the capabilities of the particular robotic device. Process 400 then proceeds to act 430, where grasp strategy planning for the robotic device is performed. The grasp planning strategy may, for example, select from among multiple grasp candidates, each of which describes a manner in which to grasp the target object. Grasp strategy planning may include, but is not limited to, the placement of a gripper of the robotic device on (or near) a surface of the selected object and one or more movements of the robotic device (e.g., a grasp trajectory) necessary to achieve such gripper placement on or near the selected object. As used herein, the terms “placement of a gripper,” “gripper placement,” or simply “placement” are interchangeable and refer to the location and/or orientation of a gripper relative to a surface of an object. A gripper placement may be specified in any suitable way to describe a spatial relation between a gripper and an object it has grasped or is planning to grasp. For instance, a gripper placement may include spatial coordinates (e.g., x-y coordinates for a particular face of the object or x-y-z coordinates in a three-dimensional reference space) specified relative to a geometric center of the object, relative to a center of mass of the object, or relative to a different frame of reference. In some embodiments, a gripper placement may include information about a face of the object to be grasped, whereas in other embodiments, the particular face of the object to be grasped may not be explicitly specified, but may be determined based on the spatial coordinates associated with the gripper placement. In some embodiments, a gripper placement may include an indication of one or more contact areas (or estimated contact areas) between the gripper and the object, for example, when the surface of the object is not uniform and/or flat (e.g., when the surface of the object is curved, angled, etc.). As described in more detail below, each grasp candidate may be associated with a gripper placement that specifies a spatial relationship between a gripper of a robotic device and a particular object in the environment of the robotic device. Process 400 then proceeds to act 440, where the target object is grasped by the robotic device according to the grasp strategy planning determined in act 430. Although acts 420 and 430 are depicted and described above as separate acts that are performed serially, it should be appreciated that in some embodiments, acts 420 and 430 may be combined such that, for example, grasp strategy planning in act 430 may inform the object selection process of act 420.

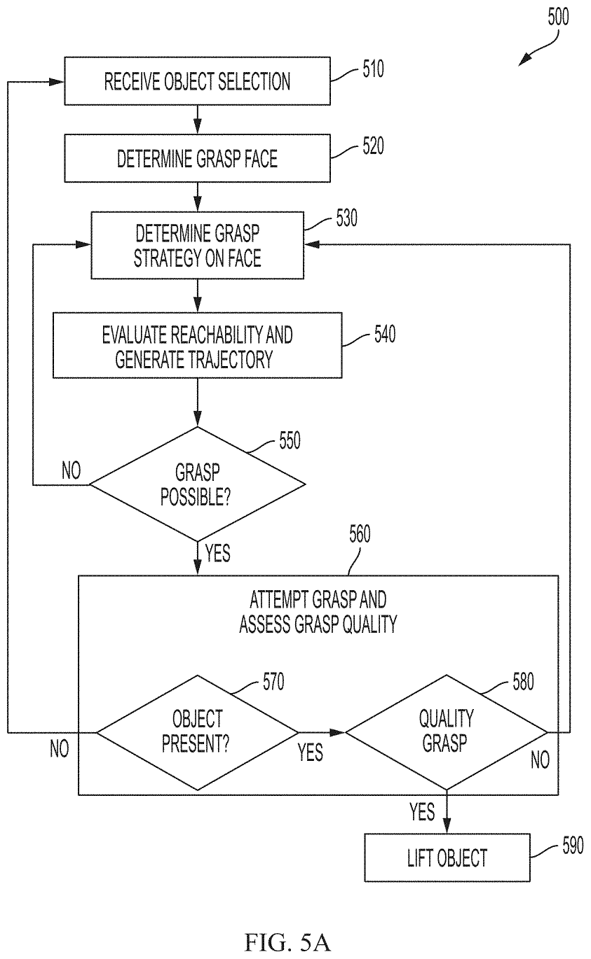

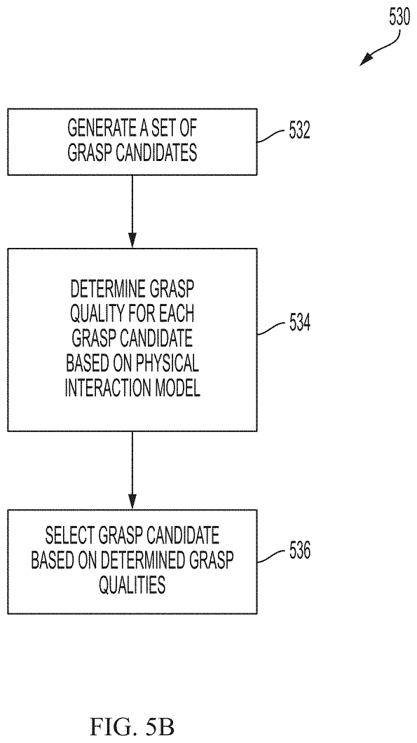

Ensuring a secure grasp on an object is important to help a robotic device that performs so-called “pick and place” operations using a vacuum-based gripper to move the object efficiently and without damage. FIG. 5A illustrates a flowchart of a process 500 for performing grasp strategy planning (e.g., corresponding to act 430 of process 400) in accordance with some embodiments. In act 510, a selection of a target object to be grasped by the robotic device is received. For instance, a target object selected in act 420 of process 400 is provided as input to the grasp strategy planning process. In some embodiments, multiple candidate target objects may be selected in act 420 of process 400 and grasp strategies for each of the multiple candidate target objects may be evaluated using the techniques described herein. Process 500 then proceeds to act 520, where one of a plurality of faces of the selected object is selected for grasping. In practice, a target object typically has two types of surfaces that are suitable for grasping by a vacuum-based gripper, as described in more detail below. As described herein, in some embodiments, acts 520 and 530 are merged into a single act.

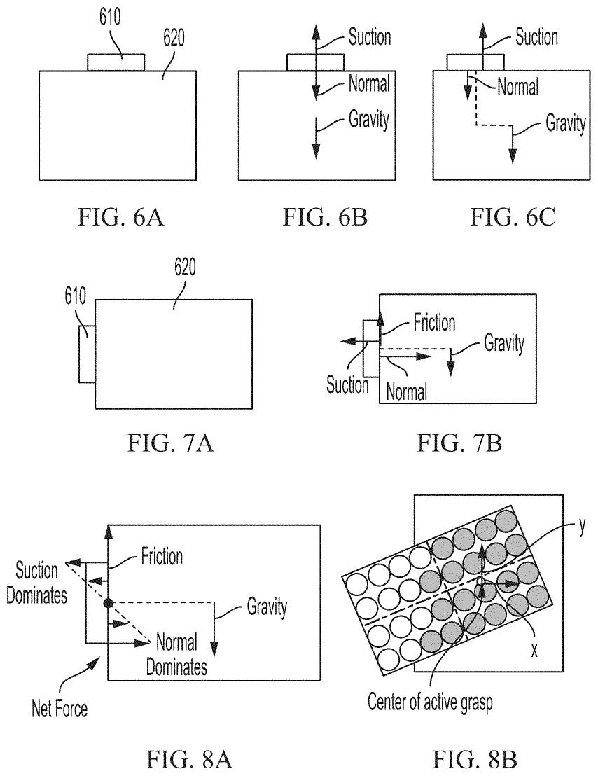

FIG. 6A-6C schematically illustrate a “top pick” in which the gripper 610 is arranged to contact with a horizontal (top) surface of the object 620. FIG. 6B shows the top pick of FIG. 6A annotated with different forces acting on the object 620 when the gripper 610 is located in the center of the top face. FIG. 6C shows the top pick of FIG. 6C annotated with different forces acting on the object 620 when the gripper 610 is located off-center on the top face. In the examples shown in FIGS. 6B and 6C, an object with uniform density is assumed, such that the center of mass of the object 620 is located at the geometric center of the box as well. As can be observed from the force diagrams in FIGS. 6B and 6C, positioning the gripper in the center of the top face results in the applied suction force acting directly opposite the gravitational force on the object (since uniform density is assumed in this example), whereas positioning the gripper off-center on the top face results in a moment, the lever arm of which is represented by a horizontal dashed line in FIG. 6C. In some embodiments, the center of mass of the object to be grasped may be estimated before grasping the object and the location of the gripper may be positioned at a location directly over the center of mass, if possible, to reduce or eliminate any generated moment caused by the suction force being applied off-center of the estimated location of the center of mass.

FIGS. 7A-B schematically illustrate a “face pick” grasp in which the gripper 610 is arranged to contact with a vertical surface of the object 620. When grasping boxes arranged in a stack of boxes, the vertical surface used for face picking is typically the face of the box oriented parallel to the robotic device to execute a front face pick, though in some instances, a vertical surface oriented at some other orientation relative to (e.g., perpendicular to) the robotic device may be used to execute a side face pick. FIG. 7B shows that in the face pick scenario, in addition to the gravitational and suction forces described above in a top pick scenario, a force due to friction between the gripper 610 and object 620 is also introduced. As shown, the moment induced in the face pick scenario of FIG. 7B is larger than the moment induced in the top pick scenario of 6C. Due to the larger moment arm for the face pick scenario relative to the top pick scenario, the required suction force to face pick is generally greater. It should be appreciated, however, that a force due to friction between the gripper and the object may also be present in the top pick scenario. For instance, when the top of the object is not level, a component of the gravitational force will act in the plane of the top face of the object resulting in a frictional force in that plane.

FIG. 8A illustrates a force diagram of a face pick, showing the anticipated forces between the gripper and the target object. Face picks in particular are challenging to maintain a good grasp quality because of cascade failure, where suction cups located near the top of the gripper are overloaded with force which tends to separate the gripper from the object. Some embodiments are directed to techniques for modelling these forces and determining gripper positioning to reduce grasp failures. FIG. 8B illustrates the position of the individual suction cups on the surface of the box indicating that some of the suction cups may be activated (e.g., provided with suction), whereas other suction cups may not be activated. The center of the active grasp may be calculated based only on the suction cups that are activated at a particular point in time. In some embodiments, the set of suction cups that are considered to be “activated” for use in grasp strategy planning (e.g., for modeling using the physical-interaction model of the forces between each of the activated suction cups and the object) may be different than the set of suction cups that are actually activated when the object is grasped. For instance, the set of activated suction cups for the purposes of grasp strategy planning may include only suction cups that are completely overlapping with a surface of the object to be grasped, whereas during actual grasping of the object, one or more suction cups that are partially (i.e., not completely) overlapping with the surface of the object may also be included in the set of activated suction cups. In some embodiments, partially overlapping suction cups may also be included in the set of suction cups used to model forces during grasp strategy planning.

Returning to process 500, determining which face to grasp in act 520 may be performed in some embodiments based, at least in part, on one or more heuristics. For instance, due to the smaller moment arms generally associated with top picks (though not always the case as described herein), a top face may be selected unless there are certain considerations in which a face pick would be preferred. Such considerations may include, but are not limited to, the object being located high, such that a top pick is not possible, and whether one or more manipulations of the object need to be performed (e.g., to determine one or more dimensions of the object) for which a face pick would be more desirable. Other considerations may include, but are not limited to, a scenario in which a top face of the object to be picked has a smaller area than a front (or side) face, such that performing a top-pick would engage fewer suction cups of the gripper compared with a face pick.

After selection of a grasp face in act 520, process 500 proceeds to act 530, where a grasp strategy for grasping the object on the selected grasp face is determined. In some embodiments, a plurality of grasp candidates are generated in act 520 and the grasp candidate likely to produce the most secure grasp is selected as the determined grasp strategy. The inventors have recognized and appreciated that maximizing the area overlap between the gripper and the face of the object to be grasped does not necessarily result in the most secure grasp possible. In some embodiments, the physical interactions between individual suction cups of the gripper and the object face are modeled to evaluate grasp quality for different grasp candidates. Including information about the locations of the suction cups on the face of the object, and the forces they are expected to experience when the object is grasped, facilitates an evaluation of the quality of the grasp prior to grasping the object. As discussed above, a vacuum-based gripper for a robotic device may include a plurality of suction cups. A physics-based evaluation function used to determine grasp quality in accordance with the techniques described herein may determine grasp quality based on which suction cups of the gripper are activated (e.g., as shown in FIG. 8B) and the forces that the activated suction cups are expected to experience when engaged with the object. Such an evaluation function allows for calculation of the capacity of the grasp as a function of the gripper pose with respect to the object face.

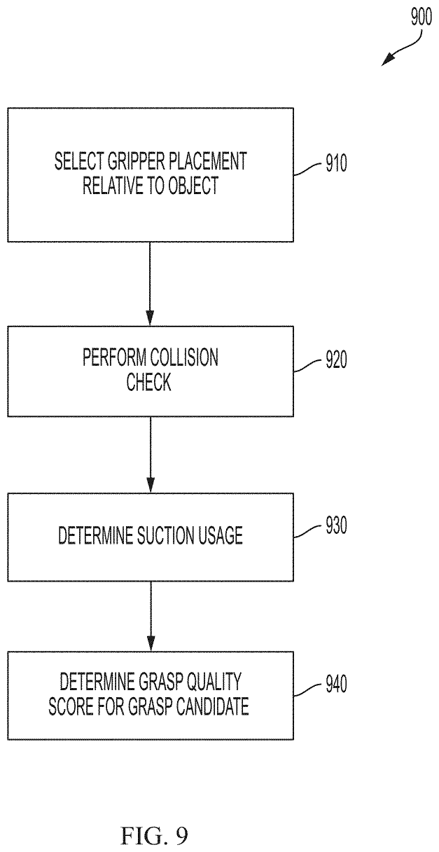

FIG. 5B illustrates a flowchart of a process for determining a grasp strategy in accordance with some embodiments. In act 532, a set of grasp candidates, each with different combinations of gripper placement (e.g., location, rotation) and/or suction cup activations may be obtained by simulating possible gripper positions and/or suction cup activations with respect to the object face. In act 534, each of the grasp candidates in the set is evaluated using a physics-based model describing physical interactions between the gripper and the object to determine an estimated grasp quality for the grasp candidate. Evaluation with the physics-based model enables an examination of which face of the object is best to grasp and/or for a given grasp face, which gripper orientation and suction cup activation is likely to result in the most secure grasp. In some embodiments, the physics-based model is used to assign to each of the grasp candidates in the set, a grasp quality score. In act 536, one of the grasp candidates is selected based on the determined grasp qualities for the set of grasp candidates. For instance, the grasp candidate with the highest score (i.e., highest quality grasp) may be output from act 530 as the determined grasp strategy to pick the object. Generation of grasp candidates according to some embodiments are described in more detail below with regard to FIG. 9.

Although shown as two separate acts in process 500, in some embodiments, acts 520 and 530 are merged into a single act. For instance, in some embodiments, a particular face of an object may not be selected and grasp candidates for just the selected face determined. Rather, in some embodiments a set of grasp candidates for a plurality of faces of an object to be grasped may be determined. The plurality of faces may include all faces of an object capable of being grasped by the robotic device for a particular scenario. By generating a set of grasp candidates for all pickable faces of an object, it may not be necessary to use one or more heuristics (e.g., top picks are better than face picks) to determine a grasp strategy, as described herein. Rather, the physics-based evaluation function that models the physical interactions between the object and the gripper may be used to determine the desired or “target” face of the object to grasp.

Process 500 then proceeds to act 540, where the reachability of the object using the arm of the robotic device is determined and a trajectory for the arm is generated. As discussed above, some types of grasp strategies may not be feasible or favored relative to other grasp strategies. For instance, a collision check between the gripper and the objects surrounding the target object may be performed to ensure that the gripper can be placed at the position specified by the determined grasp strategy. Additionally, although a grasp might perform well according to the modeled physical interactions between the gripper and the object (e.g., the score associated with the grasp strategy is high), the object may not be reachable by the arm of the robotic device. For instance, the arm of the robotic device may have a limited range of motion and must also avoid collision with surrounding environmental obstacles (e.g., truck walls and ceiling, racking located over the selected object, other objects in the vicinity of the selected object, etc.).

In some embodiments, the fact that the object (or a particular face of the object) may not be reachable by the arm of the robotic device in its current location may not be determinative if it is possible for the robotic device to change its location. Accordingly, in some embodiments the ability of the robotic device to reposition itself (e.g., by moving its mobile base) relative to the object may be taken into consideration when determining whether an object is reachable by the robotic device. Although moving the location of the robotic device to change its reachability (e.g., moving the robotic device closer to a stack of objects) may take more time than keeping the base of the robotic device stationary and selecting a different grasp strategy, if it is preferable for robotic device to grasp a particular object in a particular way relative to other objects (e.g., because of a risk of collapsing a stack of objects), the desire to pick that particular object in a particular way may outweigh the time delay needed to move the robotic device to a position where the object is reachable. In some embodiments, a decision on whether to move the robotic device to change its reachability may be made based, at least in part, on whether a particular grasp candidate being considered would be reachable if the robot moved and all of the previously-examined (e.g., higher scoring) grasp candidates have also not been reachable by the robotic device. In such an instance, it may be determined to control the robotic device to change its position relative to the objects in its environment to make them more reachable.

Process 500 then proceeds to act 550, where it is determined based on the analysis performed in act 540 whether the grasp strategy determined in act 530 is possible based on the reachability and/or trajectory constraints. If it is determined that the grasp is not possible, process 500 returns to act 530, where a different grasp strategy is determined. Alternatively, when it is determined that the grasp is not possible but may be possible if the robotic device is moved (e.g., closer to the object), the robotic device may be controlled to drive to a location where the grasp is possible, as described above. In some embodiments, the plurality of grasp candidates that are generated and evaluated (e.g., scored or ranked) in act 530 are stored and made available throughout the grasp planning process 500, such that when a grasp strategy is rejected or fails at any point of the process following act 530, the next best grasp candidate (e.g., next highest scoring grasp candidate) can immediately be selected rather than having to run additional simulations. Having a set of evaluated grasp candidates available throughout the grasp planning process increases the speed by which a final grasp candidate can be selected, resulting in less downtime for the robotic device between object picks. In some embodiments, when a grasp strategy is rejected or fails, one or more additional grasp candidates may be computed and added to the set of grasp candidates.

In some embodiments, rather than returning to act 530 after determining that a selected grasp strategy is not possible in act 550, process 550 may instead return to act 520 to determine a different (or same) grasp face to grasp the object. For instance, if the reason the grasp strategy failed in the act 550 was due to the object being located too close to an obstruction to execute a top pick, it may subsequently be determined in act 520 that top picking is not possible, and a face pick grasp strategy should be selected. As described above, in some embodiments, first determining a grasp face in act 520 and subsequently determining a grasp strategy for the determined grasp face in act 530 are not implemented using separate acts. Rather, the set of grasp candidates determined and evaluated in act 530 may be based on simulated grasps from multiple grasp faces such that the set of grasp candidates includes grasp candidates corresponding to both top pick and face pick grasp strategies. In such implementations, one or more heuristics (e.g., top picks being preferred over face picks) may not be used to determine a ranking or score assigned to a grasp candidate. Rather, a physics-based interaction model describing the physical interaction between the object and the gripper may be used to determine a preferred or target grasp strategy. For example, an object may have a small top face and a much larger front face. In such an instance, a face pick may be associated with a higher score due to a larger number of suction cups in the gripper being able to contact the front face compared to the top face.

If it is determined in act 550 that the selected grasp strategy is possible, process 500 proceeds to act 560, where the robotic device is controlled to attempt grasping of the target object based on the selected grasp strategy. As part of act 560 to attempt to grasp the target object, an image of the environment may be captured by the perception module of the robotic device, and the image may be analyzed in act 570 to verify that the target object is still present in the environment. If it is determined in act 570 that the target object is no longer present in the environment, process 500 returns to act 510, where a different object in the environment is selected (e.g., in act 420 of process 400) for picking. If it is determined in act 570 that the target object is present, act 560 continues to act 580, where the quality of the grasp is assessed to determine whether the actual grasp of the target object is likely sufficient to move the object along a planned trajectory without dropping the object. For instance, the grasp quality of each of the activated suction cups in the gripper may be determined to assess the overall grasp quality of the grasped object. If it is determined in act 580 that the grasp quality is sufficient, process 500 proceeds to act 590, where the object is lifted by the gripper. Otherwise, if it is determined that the grasp quality is not sufficient (e.g., by comparing the grasp quality to a threshold value), process 500 returns to act 530 (or act 520 as described above) to determine a different grasp strategy. As discussed above, the different grasp strategy may be selected as the next best grasp strategy based on its ranking or score in the set of grasp candidates generated and evaluated in act 530.

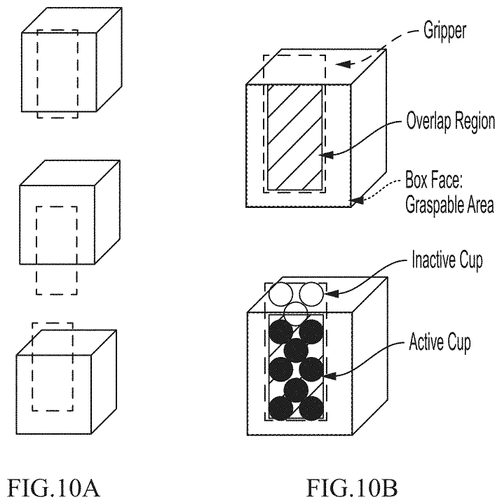

FIG. 9 illustrates a process 900 for generating grasp candidates in accordance with some embodiments. Process 900 begins in act 910, where a gripper placement relative to an object for the grasp candidate is selected. For instance, FIG. 10A schematically illustrates three different potential gripper placements on a front face of an object, with all of the placements having the same orientation (a vertical orientation). Although only three potential gripper placements are shown, it should be appreciated that other gripper placements (e.g., the gripper oriented at an angle) may also be considered.

Process 900 then proceeds to act 920 in which a collision check is performed to ensure that the gripper can be placed at the placement selected in act 910. If the gripper cannot be placed on the target object according to the selected placement, the grasp candidate is rejected and process 900 proceeds to act 910 to select a new gripper placement relative to the target object. Any suitable number of collision-free gripper placements may be used to generate grasp candidates, and embodiments are not limited in this respect.

After determining a gripper placement is collision-free, process 900 proceeds to act 930 in which suction usage (e.g., which suction cups of the gripper could/should be activated) is determined based on the gripper placement selected in act 910. For instance, if a gripper placement is selected as the partial hang off top gripper position (the lower position shown in FIG. 10A), only some of the suction cups in the gripper (e.g., the ones located completely over the surface of the box face) may be selected to be activated, whereas the other suction cups (e.g., the ones hanging off the box face) may be selected to be deactivated, as shown in FIG. 10B.

Process 900 then proceeds to act 940, where a grasp quality score for the grasp candidate is determined using a physics-based model that includes one or more forces between the target object and the gripper, as described above. It should be appreciated that process 900 may be repeated any number of times to generate the set of grasp candidates to ensure backup grasping candidates are available if needed, as discussed above. In some embodiments, process 900 may be informed by using an optimization technique that selects grasp candidate configurations having the highest likelihood of success.

Extracting boxes quickly and efficiently is important for ensuring a high pick rate of a robotic device. In some cases, small and/or lightweight boxes may be grouped in clusters such that they may be able to be grasped simultaneously by a gripper of a robotic device. For instance, under certain circumstances (e.g., the neighboring objects have similar depth), neighboring object(s) may not be considered as obstacles to grasping the target object, but instead it may be possible to grasp one or more of the neighboring object(s) and the target object with the gripper at the same time, also referred to as a “multi-pick.”

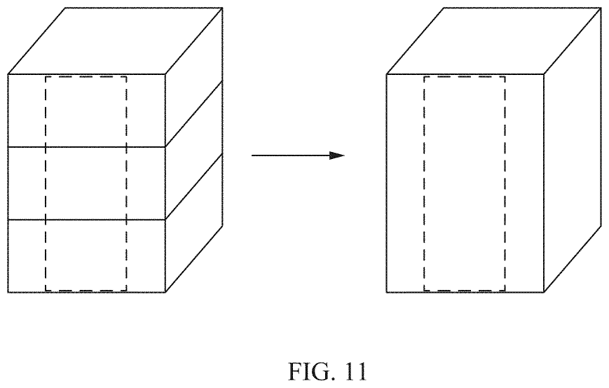

FIG. 11 schematically illustrates a scenario in which the gripper placement may be arranged such that both a target object in the middle of a stack and multiple other neighboring objects (in this case one above and one below the target object) can be grasped by the gripper at the same time. In some embodiments, multi-picking may be implemented by considering the group of objects as the new “target object” replacing the target object provided as input to the grasp strategy evaluation process.

Although illustrated as separate elements, the modules described and/or illustrated herein may represent portions of a single module or application. In addition, in certain embodiments one or more of these modules may represent one or more software applications or programs that, when executed by at least one computing device, may cause the at least one computing device to perform one or more tasks. For example, one or more of the modules described and/or illustrated herein may represent modules stored and configured to run on one or more of the at least one computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally, or alternatively, one or more of the modules recited herein may transform a processor, volatile memory, non-volatile memory, and/or any other portion of a physical computing device from one form to another by executing on the at least one computing device, storing data on the at least one computing device, and/or otherwise interacting with the at least one computing device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that embodiments of a robot may include at least one non-transitory computer-readable storage medium (e.g., a computer memory, a portable memory, a compact disk, etc.) encoded with a computer program (i.e., a plurality of instructions), which, when executed on a processor, performs one or more of the above-discussed functions. Those functions, for example, may include control of the robot and/or driving a wheel or arm of the robot. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A method of determining a grasp strategy to grasp an object with a gripper of a robotic device, the method comprising:
generating, by at least one computing device, a set of grasp candidates to grasp a target object, wherein each of the grasp candidates includes information about a gripper placement relative to the target object;
determining, by the at least one computing device, for each of the grasp candidates in the set, a grasp quality, wherein the grasp quality is determined using a physical-interaction model including one or more forces between the target object and the gripper located at the gripper placement for the respective grasp candidate;
selecting, by the at least one computing device based at least in part on the determined grasp qualities, one of the grasp candidates; and
controlling, by the at least one computing device, the robotic device to attempt to grasp the target object using the selected grasp candidate.

2. The method of claim 1, wherein generating a grasp candidate in the set of grasp candidates comprises:
selecting a gripper placement relative to the target object;
determining whether the selected gripper placement is possible without colliding with one or more other objects in an environment of the robotic device; and
generating the grasp candidate in the set of grasp candidates when it is determined that the selected gripper placement is possible without colliding with one or more other objects in the environment of the robotic device.

3. The method of claim 1, further comprising:
determining that at least one object other than the target object is capable of being grasped at a same time as the target object; and
determining the information about the gripper placement for the grasp candidate to grasp both the target object and the at least one object other than the target object at the same time.

4. The method of claim 1, wherein generating a grasp candidate in the set of grasp candidates comprises:
determining, based on the information about the gripper placement, a set of suction cups of the gripper to activate; and
associating with the grasp candidate, information about the set of suction cups of the gripper to activate,
wherein determining the grasp quality for a respective grasp candidate using a physical-interaction model is further based, at least in part, on the information about the set of suction cups of the gripper to activate

5. The method of claim 4, further comprising:
representing in the physical-interaction model, forces between the target object and each suction cup in the set of suction cups of the gripper to activate; and
determining the grasp quality for the respective grasp candidate based on an aggregate of the physical-interaction model forces between the target object and each suction cup in the set of suction cups of the gripper to activate.

6. The method of claim 4, wherein determining the set of suction cups of the gripper to activate comprises including, in the set of suction cups, all suction cups in the gripper completely overlapping a surface of the target object.

7. The method of claim 1, wherein the set of grasp candidates includes a first grasp candidate having a first offset relative to the target object and a second grasp candidate having a second offset relative to the target object, wherein the second offset is different from the first offset.

8. The method of claim 1, wherein the set of grasp candidates includes a first grasp candidate having a first orientation relative to the target object and a second grasp candidate having a second orientation relative to the target object, wherein the second orientation is different from the first orientation.

9. The method of claim 1, wherein selecting based, at least in part, on the determined grasp qualities, one of the grasp candidates comprises selecting the grasp candidate in the set of grasp candidates with the highest grasp quality.

10. The method of claim 1, further comprising:
determining, by the at least one computing device, whether the selected grasp candidate is feasible; and
performing, by the at least one computing device, at least one action when it is determined that the selected grasp candidate is not feasible.

11. The method of claim 10, wherein performing at least one action comprises selecting a different grasp candidate from the set of grasp candidates, selecting a different target object to grasp or controlling, by the at least one computing device, the robotic device to drive to a new position closer to the target object.

12. The method of claim 11, wherein selecting a different grasp candidate from the set of grasp candidates comprises selecting the grasp candidate with a next highest grasp quality.

13. The method of claim 10, wherein determining whether the selected grasp candidate is feasible is based, at least in part, on at least one obstacle located in an environment of the robotic device and/or a movement constraint of an arm of the robotic device that includes the gripper.

14. The method of claim 1, further comprising:
measuring, a grasp quality between the gripper and the target object after controlling the robot to attempt to grasp the target object;
selecting, by the at least one computing device, a different grasp candidate from the set of grasp candidates when the measured grasp quality is less than a threshold amount; and
controlling the robotic device to lift the target object when the measured grasp quality is greater than the threshold amount.

15. The method of claim 1, further comprising:
receiving, by the at least one computing device, a selection of the target object to grasp by the gripper of the robotic device.

16. A robotic device, comprising:
a robotic arm having disposed thereon, a suction-based gripper configured to grasp a target object; and
at least one computing device configured to:
generate a set of grasp candidates to grasp the target object, wherein each of the grasp candidates includes information about a gripper placement relative to the target object;
determine, for each of the grasp candidates in the set, a grasp quality, wherein the grasp quality is determined using a physical-interaction model including one or more forces between the target object and the gripper located at the gripper placement for the respective grasp candidate;
select based, at least in part, on the determined grasp qualities, one of the grasp candidates; and
control the arm of the robotic device to attempt to grasp the target object using the selected grasp candidate.

17. The robotic device of claim 16, wherein generating a grasp candidate in the set of grasp candidates comprises:
selecting a gripper placement of the suction-based gripper relative to the target object;
determining whether the selected gripper placement is possible without colliding with one or more other objects in an environment of the robotic device; and
generating the grasp candidate in the set of grasp candidates when it is determined that the selected gripper placement is possible without colliding with one or more other objects in the environment of the robotic device.

18. The robotic device of claim 16, wherein the suction-based gripper includes one or more suction cups, and wherein the at least one computing device is further configured to:
determine, based on the information about the gripper placement, a set of suction cups of the one or more suction cups to activate; and
associate with the grasp candidate, information about the set of suction cups of the plurality of suction cups to activate.

19. The robotic device of claim 16, wherein the at least one computing device is further configured to:
measure a grasp quality between the gripper and the target object after controlling the robot to attempt to grasp the target object;
select a different grasp candidate from the set of grasp candidates when the measured grasp quality is less than a threshold amount; and
control the robotic arm to lift the target object when the measured grasp quality is greater than the threshold amount.

20. A non-transitory computer readable medium encoded with a plurality of instructions that, when executed by at least one computing device, perform a method, the method comprising:
generating a set of grasp candidates to grasp a target object, wherein each of the grasp candidates includes information about a gripper placement relative to the target object;
determining for each of the grasp candidates in the set, a grasp quality, wherein the grasp quality is determined using a physical-interaction model including one or more forces between the target object and the gripper located at the gripper placement for the respective grasp candidate;
selecting based at least in part on the determined grasp qualities, one of the grasp candidates; and
controlling the robotic device to attempt to grasp the target object using the selected grasp candidate.
